(19) United States
(12) Patent Application Publication
(10) Pub. No.: US 2005/0115607 A1
(43) Pub. Date: Jun. 2, 2005

(54) Liquid supply cutoff valve and liquid supply cutoff device incorporating the same

(76) Inventor: Hitoshi Inoue, Kitakatsuragi-gun (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 10/883,958

(22) Filed: Jul. 2, 2004

(30) Foreign Application Priority Data
Nov. 28, 2003 (JP) 2003-399597

(51) Int. Cl. G05D 9/02

(52) U.S. Cl. 137/170.2

(57) ABSTRACT

The present invention provides a liquid supply cutoff valve that quickly shuts the liquid line of beer from a beer tank with the pressure of carbon dioxide gas at the moment a beer tank is running out of beer. The liquid supply cutoff valve of the present invention includes a primary liquid line, a secondary liquid line, a valve chest between the primary liquid line and the secondary liquid line, a spherical valve plug arranged in the valve chest, wherein the spherical valve plug is lower in specific gravity than a liquid in the liquid lines, and a valve seat arranged at the lower end opening of the secondary liquid line in the valve chest, wherein the spherical valve plug is seated on the valve seat when the spherical valve plug is upwardly shifted, and wherein an inside opening of the primary liquid line to the valve chest is set to be at a level higher than the valve seat.

### BACKGROUND OF THE INVENTION

This application claims priority to Japanese Patent Application No. 2003-399597 filed on Nov. 28, 2003, the contents of which is hereby incorporated by reference.

The present invention relates to a valve device which is installed in the middle of a liquid line for supplying beer to a beer server from a beer tank with pressure, and is quickly shut off when beer in the tank if fully consumed.

Commercial beer servers push beer out of a beer tank with pressurized carbon dioxide gas to supply beer from the beer tank. When beer still remains in the beer tank, the carbon dioxide gas pushes a surface of beer down, thereby supplies beer outwardly.

No problems are presented if beer still remains in the beer tank. When the tank is running out of beer, a mixture of froth and carbon dioxide gas are outwardly discharged in a burst. One who pours beer in a jug may sense the amount of beer close to emptiness and quickly closes a nozzle of the beer tank. Since beer is pressurized with at least one atmospheric pressure, it is difficult to avoid a burst of froth from the nozzle.

Intending to overcome the above-mentioned drawbacks, the inventors of present invention have previously disclosed a liquid supply cutoff valve in Japanese Laid Open Patent No. 2001-240194, the contents of which is hereby incorporated by reference.

Accordingly, there is a need for a liquid supply cutoff valve that quickly shuts the liquid line of beer from the beer tank with the pressure of carbon dioxide gas at the moment the beer tank is running out of beer. Furthermore, there is a need for a liquid supply cutoff device that provides ease of use by switching at least two beer tanks.

### SUMMARY

A liquid supply cutoff valve of the present invention is arranged in a liquid passage line that is pressurized by a gas, and includes a primary liquid line, a secondary liquid line, a valve chest between the primary liquid line and the secondary liquid line, a spherical valve plug arranged in the valve chest, the spherical valve plug being lower in specific gravity than a liquid in the liquid line, and a valve seat arranged at the lower end opening of the secondary liquid line in the valve chest. The spherical valve plug is seated on the valve seat when the spherical valve plug is upward shifted, and an inside opening of the primary liquid line in the valve chest is at a level higher than the valve seat. While the liquid normally flows, the spherical valve plug is maintained at the position thereof by the liquid forming an eddy. The valve plug rotates at the position thereof when the liquid rises from the inlet port of the valve chest from the primary liquid line. The cutoff valve merely forms part of the liquid line. When the liquid becomes smaller in quantity, the liquid surface in the valve chest goes down. The valve plug also drops with the gravity thereof, and is drawn to the valve seat by a negative pressure of the secondary liquid line. The pressure of the gas pushes the spherical valve plug onto the valve seat. The cutoff valve thus functions as a cutoff valve with the spherical valve plug seated on the valve seat. In accordance with the present invention, the valve seat is incorporated to cause the spherical valve plug to seat on the valve seat when the spherical valve plug is lifted up to the lower end opening of the secondary liquid line. When the liquid level goes down to the lower end opening of the secondary liquid line within the valve chest, the spherical valve plug is shifted to the side of the valve seat while still having buoyancy, and is quickly seated onto the valve seat. Before the valve chest is filled with the pressure gas, the spherical valve plug is thus seated onto the valve seat, thereby reliably preventing the gas from being discharged through the secondary liquid line.

Preferably, the liquid supply cutoff valve includes a reset unit for pushing the spherical valve plug into the valve chest when the spherical valve plug is seated on the valve seat. The reset unit resets the spherical valve plug, which has been pressed against the valve seat with the gas pressure, to an open valve state. The liquid supply cutoff valve preferably includes a gas relief valve that is arranged at a level higher than the inside opening of the primary liquid line of the valve chest. To start supplying the liquid, the gas relief valve may be opened to discharge the gas that has filled the valve chest. The supplying of the liquid is commenced with the valve chest fully filled with the liquid. The negative pressure at the time of discharging the gas quickly pushes the spherical valve plug from the seating position thereof to the valve open position thereof.

The liquid cutoff device of present invention includes a plurality of liquid cutoff valves. The liquid cutoff valves are successively set to be ready for use one by one.

Other objects, features and advantages of the present invention will be apparent to those skilled in the art upon reading and understanding the following detailed description, the accompanying drawings and the appended claims.

### BRIEF DESCRIPTION OF THE DRAWINGS

The invention may be understood with reference to the following drawings. In the drawings, like reference numerals designate corresponding parts throughout the several views. Also, the components in the drawings are not necessarily to scale.

FIG. 1 is a piping diagram of a beer server system incorporating a liquid supply cutoff valve according to the present invention;

FIG. 2 is a longitudinal section of the liquid supply cutoff valve of the present invention in a liquid supply operation;

FIG. 3 is a longitudinal section of the liquid supply cutoff valve of FIG. 2 in the liquid cutoff state thereof;

FIG. 4 is a longitudinal section of the liquid supply cutoff valve of FIG. 3 with no beer remaining in a beer tank; and

FIG. 5 is a longitudinal section of the liquid supply cutoff valve of FIG. 4 with a reset unit operated.

### DETAILED DESCRIPTION

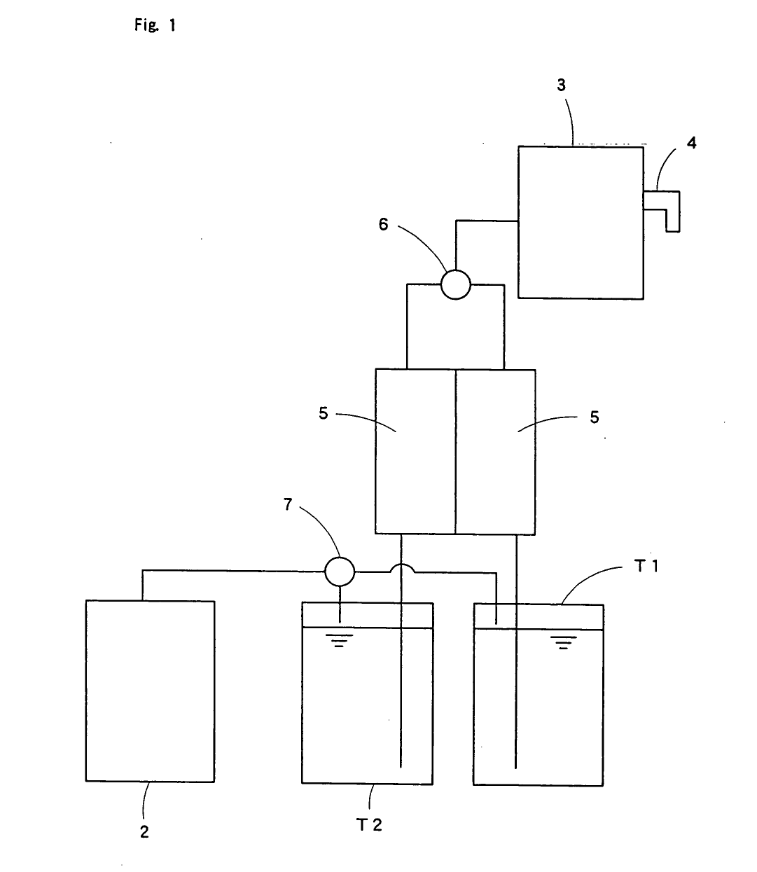

A first embodiment of the present invention is now discussed with reference to the drawings. FIG. 1 is a piping diagram of an entire beer server system incorporating a liquid supply cutoff valve according to the present invention. As shown, the beer server system includes beer tanks T1 and T2, a carbon dioxide gas cylinder 2 for applying pressure inside of the beer tanks T1 and T2, a known beer server 3 having a cooling mechanism, and a nozzle 4 for pouring out beer. Also included are liquid supply cutoff valves 5 according to the present invention.

The liquid supply cutoff valves 5 are arranged in parallel as a liquid supply cutoff device such that one liquid supply cutoff valve 5 is ready for use after the other. Accordingly, when the first tank T1 runs out of beer, beer is supplied from the second tank T2. The liquid supply cutoff valves 5 are present in the same quantity as the beer tanks T1 and T2 and are arranged downstream of the beer tanks T1 and T2.

The carbon dioxide gas cylinder 2 is connected to the beer tanks T1 and T2. A tank switching valve 6 causes one of the liquid supply cutoff valves 5 to be alternatively connected to the beer tanks T1 and T2. A gas supply switching valve 7 applies gas pressure to a selected one of the beer tanks T1 and T2.

The liquid supply cutoff valves 5 are respectively arranged for the beer tanks T1 and T2, thereby forming the respective supply lines. The supply lines are thus exclusively selected, permitting a total amount of beer to be supplied in succession, for example, in a large restaurant. Since the number of the beer tanks T1 and T2 equals the number of liquid supply cutoff valves 5, a reinstallation operation of the liquid supply cutoff valve 5 is not needed. Serving beer is smoothly performed.

The first embodiment of the present invention is only exemplary. Alternatively, a pair of liquid supply cutoff valves 5 and beer tanks may be used. The number of pairs of liquid supply cutoff valves 5 and beer tanks may be three or more so that the pairs may be alternately connected for use.

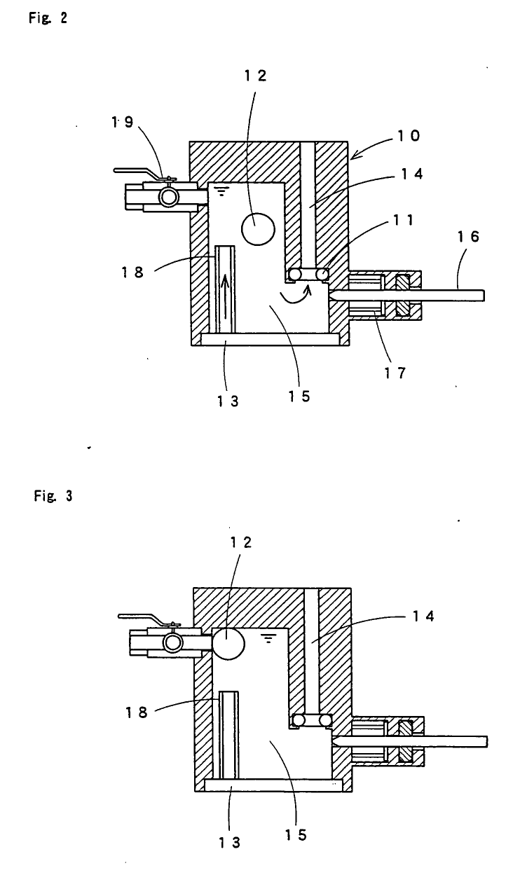

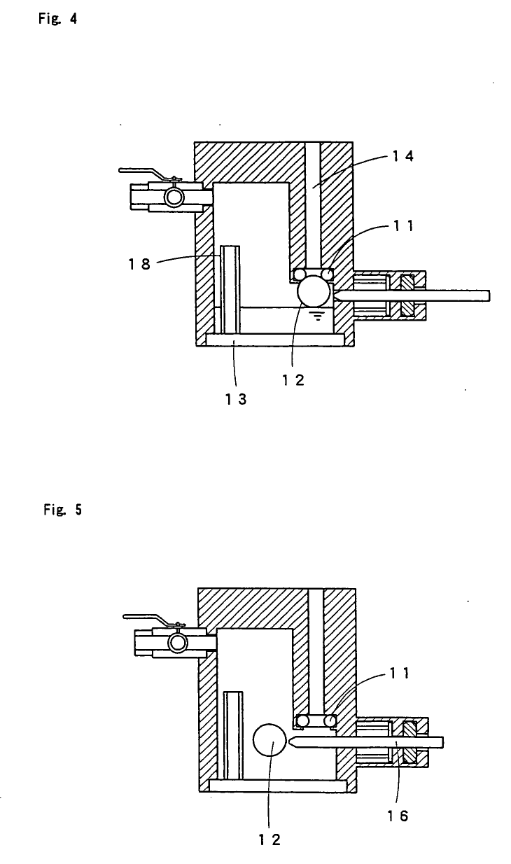

FIGS. 2 through 4 illustrate the internal structure of the liquid supply cutoff valve 5, which is the essence of the present invention. As shown, the liquid supply cutoff valve 5 includes a housing 10, an o-ring 11, a spherical valve plug 12 which is lower in specific gravity than a liquid such as beer, a primary liquid line 13 of the valve, and a valve chest 15. A valve seat (at the o-ring 11) is formed at a lower end opening of the secondary liquid line 14 within the valve chest 15 and is aligned to receive the spherical valve plug 12 when the spherical valve plug 12 is lifted upward. A reset rod 16 is urged at a position as shown by a spring 17. When the spherical valve plug 12 is seated onto the o-ring 11 of the valve seat, the reset rod 16 is used to push the spherical valve plug 12 inwardly into the valve chest 15 to revert back to a normal liquid supply state.

The housing 10 and the spherical valve plug 12 may be made of any appropriate materials. For bulk production, the housing 10 and the spherical valve plug 12 are preferably made of a synthetic resin using a molding technique. It is a structural requirement that the valve seat (and o-ring 11) is lower in level (or relative elevation) than an inside opening of the primary liquid line 13 in the valve chest 15. In such an arrangement, the liquid forms an eddy within the valve chest 15. The secondary liquid line 14 must be larger in cross section (or diameter) than an inlet port 18 to restrict the current speed of the liquid to control the turbulent flow of the liquid.

A gas relief valve 19, arranged at a level higher than the top end of the inlet port 18 of the primary liquid line 13, discharges the gas, which fills the valve chest 15, at the initial step of the liquid supply (i.e., during reset operation). After the gas relief valve 19 is opened to discharge gas during the reset operation and then closed, the supplying of the liquid is commenced with no gas remaining. During the reset step, the operation of the gas relief valve 19 allows the valve chest 15 to be fully filled with the liquid. In conjunction with the reset rod 16, the gas relief valve 19 sets the spherical valve plug 12 to a position appropriate for liquid supplying.

The operation of the liquid supply cutoff valve 5 will now be discussed. FIG. 2 shows the liquid supply cutoff valve 5 in a state in which the nozzle 4 is opened to allow beer to be pressurized by a carbon dioxide gas. Beer is introduced through the inlet port 18 into the valve chest 15 as shown by the arrows in FIG. 2, and forms a large eddy while running into the secondary liquid line 14 through the valve seat (and corresponding o-ring 11). Beer flows into the beer server 3 of FIG. 1. The spherical valve plug 12 being lower in specific gravity than the liquid attempts to float with buoyancy within the valve chest 15, but is captured within the eddy. The spherical valve plug 12 is relatively stabilized at the position as shown in FIG. 2 while being rotated.

When the supply of beer is suspended with the nozzle 4 closed, the liquid supply cutoff valve 5 takes a state shown in FIG. 3. The nozzle 4 functions as a final liquid supply suspension valve. Since the liquid supply cutoff valve 5 is located in the middle of the beer supply line, the beer is captured within the valve chest 15. The spherical valve plug 12 being lower in specific gravity than the liquid is lifted to the top level within the valve chest 15. Since the liquid supply cutoff valve 5 remains stable until the nozzle 4 is again opened, the spherical valve plug 12 keeps the position thereof as shown.

When the supply of beer resumes with the nozzle 4 opened, the liquid within the valve chest 15 forms a liquid supply line, and the spherical valve plug 12 is involved in the liquid supply line as shown in FIG. 2. If the inlet port 18 is lower in level than the valve seat (and corresponding o-ring 11), it becomes difficult to stabilize the spherical valve plug 12 at a position sufficient high in level, and the spherical valve plug 12 is expected to be drawn to the seating position on the o-ring 11 of the valve seat, thereby hinder (or completely blocking) the flow of liquid. The inlet port 18 must be higher in level than the valve seat 11.

When the beer tank T1 runs out of beer in the state shown in FIG. 2, the liquid in the valve chest 15 is pushed into the secondary liquid line 14 while forming a turbulent flow. As the liquid level drops, the spherical valve plug 12 also drops in position. Since the carbon dioxide gas still pressurizes the liquid, the spherical valve plug 12 is pressed against the o-ring 11 of the valve seat, thereby functioning as a cutoff valve. Since the application of the carbon dioxide gas is still continuous, the spherical valve plug 12 remains seated on the o-ring 11 of the valve seat.

If the empty beer tank T1 is switched to a full beer tank T2, the gas relief valve 19 is opened. The gas relief valve 19 evacuates the gas from the valve chest 15. The reset rod 16 is pushed in a direction represented by an arrow after the valve chest 15 is filled with the liquid as shown in FIG. 5. The spherical valve plug 12 comes off the valve seat 11 against the pressure of the carbon dioxide gas, thereby permitting the liquid to flow. When the liquid flow is stabilized, the state shown in FIG. 2 is maintained.

The reset rod 16 is used to revert the spherical valve plug 12 back to the normal position in this preferred embodiment of the present invention. Alternatively, a pressure higher than the pressure of the carbon dioxide gas may be applied from downstream. Furthermore, a cam mechanism may be employed to push the reset rod 16.

Although the present invention is shown and described with respect to certain embodiments, it is obvious that equivalents and modifications will occur to those skilled in the art upon reading and understanding the specification and the claims. The present invention includes all such equivalents and modifications and is limited only by the scope of the claims. For example, the present invention has been discussed with respect to a beer server. However, the present invention may be used for other liquids, such as, for example, carbonated drinks, juices and the like.

1. A liquid supply cutoff valve arranged in a liquid line that is pressurized by a gas, the liquid supply cutoff valve comprising:
a primary liquid line;
a secondary liquid line;
a valve chest between the primary liquid line and the secondary liquid line;
a spherical valve plug arranged in the valve chest, wherein the spherical valve plug is lower in specific gravity than a liquid in the liquid lines; and
a valve seat arranged at the lower end opening of the secondary liquid line in the valve chest, wherein the spherical valve plug is seated on the valve seat when the spherical valve plug is upwardly shifted, and
wherein an inside opening of the primary liquid line to the valve chest is set to be at a level higher than the valve seat.

2. The liquid supply cutoff valve according to claim 1, further comprising a reset unit for pushing the spherical valve plug into the valve chest when the spherical valve plug is seated on the valve seat.

3. The liquid supply cutoff valve according to claim 1, further comprising a gas relief valve that is arranged at a level higher than the inside opening of the primary liquid line of the valve chest.

4. A liquid cutoff device comprising:
a plurality of liquid cutoff valves, each of said plurality of valves having:
a primary liquid line;
a secondary liquid line;
a valve chest between the primary liquid line and the secondary liquid line;
a spherical valve plug arranged in the valve chest, wherein the spherical valve plug is lower in specific gravity than a liquid in the liquid lines; and
a valve seat arranged at the lower end opening of the secondary liquid line in the valve chest, wherein the spherical valve plug is seated on the valve seat when the spherical valve plug is upwardly shifted, and
wherein an inside opening of the primary liquid line to the valve chest is set to be at a level higher than the valve seat; and
wherein the plurality of liquid cutoff valves are successively set to be ready for use one by one.
